(19) United States
(12) Patent Application Publication
(10) Pub. No.: US 2004/0013234 A1
(43) Pub. Date: Jan. 22, 2004

(54) X-ray tube rotating anode with an anode body composed of composite fiber material

(75) Inventor: Wolfgang Kutschera, Aurachtal (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/609,913

(22) Filed: Jun. 30, 2003

(30) Foreign Application Priority Data
Jun. 28, 2002 (DE) 10229069.5

(51) Int. Cl. H01J 35/10

(52) U.S. Cl. 378/144

(57) ABSTRACT

A rotating anode for an x-ray tube has an anode body having a target surface with a focal ring, supported by a bearing system. The anode body is composed of composite fiber material with fibers exhibiting an especially high heat-conductivity, as well as a high mechanical strength.

### BACKGROUND OF THE INVENTION

1. Field of the Invention

The present invention concerns a rotating anode for an x-ray tube with an anode body that has a target surface for incident electrons with a focal ring, supported by means of a bearing system.

2. Description of the Prior Art

An X-ray tube with a rotating anode in which the anode plate is composed of molybdenum alloy is known from Krestel, “Imaging system for medical diagnostics”, page 157f. An x-ray-active cover layer made of a tungsten-rhenium alloy is deposited on the base body. A graphite body is mounted under the anode plate for heat storage, dissipation, and radiation, such that the anode plate has a soldered interconnection of the Mo and C substrate, in which the heat spreads out corresponding to the heat conductivity and heat capacity. The WRe alloy of the cover layer can be 0.6 to 1.6 mm thick.

In x-ray tubes, one of the significant technical challenges is the removal of heat from the focal point and the distribution of the heat of the focal point over a larger surface by rotating the anode, which is exposed to large mechanical forces due to the rotation and thermo-mechanical stresses. Furthermore, the generally heavyweight of the anode is a disadvantage (in particular for uses in CT) since high anode weights result in larger stresses of the rotating anode bearings in CT due to the centrifugal forces resulting from the rotation of the device.

### SUMMARY OF THE INVENTION

An object of the present invention is to provide a rotating anode for an x-ray tube of the type described above such that the high temperature originating in the rotating anode target surface is more rapidly conducted away than in a conventional focal ring, so the rotating anode can withstand the thermo-mechanical stresses for a longer time, or alternatively sustain higher power densities in a service life of the same length.

The object is inventively achieved in a rotating anode wherein the anode body is comprised of composite fiber material having fibers exhibiting an especially high heat-conductivity, as well as a high mechanical strength. It is thereby assured that the heat is dissipated and distributed away from the critical zone in the focal ring, or conducted to a cooling plate, by utilizing the very high heat conductivities that CFC materials exhibit, in particular by the use of as high-modular C-fibers. The temperature in the focal ring can be lowered by as much as 300 K thereby minimizing wear and prolonging the service life, depending on the inventive design, or the applicable short-term capacity of the x-ray tube can be correspondingly increased.

It has proven advantageous, to employ first fibers exhibiting high heat conductivity and second fibers exhibiting high strength, to orient the direction of the fiber in the anode body so that the first fibers can quickly dissipate the heat from the path of the focus and the second fibers absorb the mechanical and thermo-mechanical forces in the anode body. In accordance with the invention, for example, the first fibers can be radially formed and the second fibers can be circularly formed.

The fibers can exhibit both high heat conductivity and high strength, with the fibers oriented both radially and circularly.

It has proven expedient if the bearing system is cooled, for the first fibers to conduct the heat from the focal ring away to the bearing system.

The poor heat-conductivity transverse to the direction of the fibers can be advantageously used to keep heat away from non-cooled and therefore heat-sensitive ball bearings, if the bearing system is non-cooled and the first fibers are aligned such that a rapid heat removal from the path of the focus is enabled, but an intense heating of the bearing system is prevented, for which purpose the first fibers can be aligned primarily parallel to the bearing system.

The anode body can also inventively be fashioned as a formed component from shaped fiber mat (possibly already shaped as prepreg) or from a fiber mat semi-finished part.

### DESCRIPTION OF THE DRAWINGS

FIG. 1 is a sectional view of rotating anode in accordance with the invention with cooled plain bearing system.

FIG. 2 is a sectional view of rotating anode in accordance with the invention with cooled ball bearing system.

FIG. 3 is a sectional view of rotating anode in accordance with the invention with non-cooled ball bearing system.

### DESCRIPTION OF THE PREFERRED EMBODIMENTS

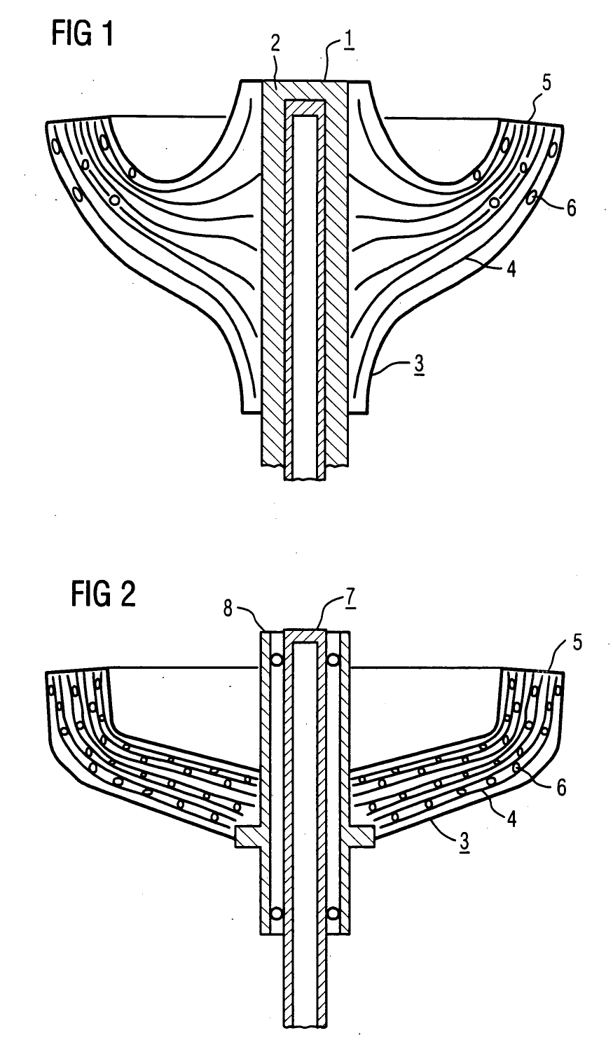

An inventive rotating anode is shown in FIG. 1 with an internally cooled plain bearing system 1, with an anode body 3 mounted at the external rotor 2 of the plain bearing system 1. This anode body 3 is comprised of a composite fiber material, for example a carbon fiber composite material, that contains fibers 4 with especially high heat-conductivity that are radially oriented such that they dissipate the heat from a path 5 of the focal point mounted in the external region of a rotating anode top down on a bracket to the cooled sliding support system. The path 5 of the focal point is fashioned by plating the anode body with heavy metals, or can be formed by a soldered-on heavy metal ring. Furthermore, the anode body 3 is provided with reinforcing fibers 6 with especially high mechanical strength that, for example, can be annularly arranged. These reinforcing fibers 6 can be distributed over the entire anode body 3 or, as is shown in FIG. 1, can be present only in the external regions that are exposed to especially high centrifugal forces. In this case, the anode body 3 is fashioned as a formed component having the desired shape.

A further exemplary embodiment of an inventive rotating anode is shown in FIG. 2 that has an internally-cooled ball bearing system 7. Again, the anode body 3 made from a composite fiber material with the heat-conducting fibers 4 and reinforcing fibers 6 is affixed to the rotor 8 of the internally cooled ball bearing system 7. The externally located oblique straight surface of the path 5 of the focal point is again plated with heavy metal, or can be a soldered-on heavy metal ring. In the exemplary embodiment according to FIG. 2, the anode body 3 is fabricated from shaped fiber mat (possibly already shaped as prepreg).

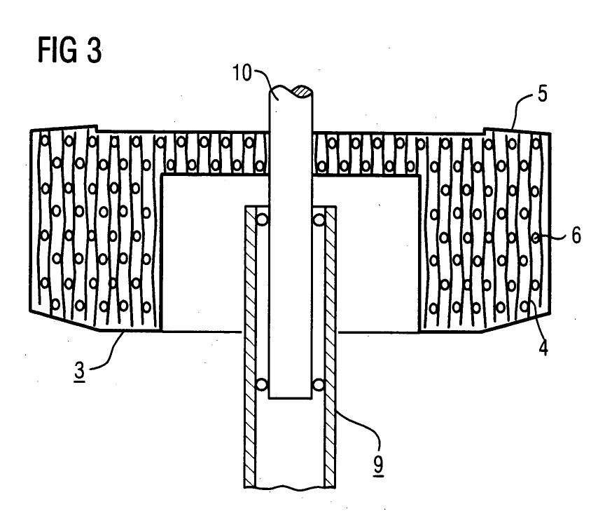

A further exemplary embodiment of a rotating anode with a non-cooled ball bearing system 9 is shown in FIG. 3. Mounted on the axis 10 of the ball bearing system 9 is the anode body 3 that is again comprised of composite fiber material and provided with heat-conducting and reinforcing fibers 4 and 6. The annular path 5 of the focal point (that is arranged at the necessary angle to properly emit x-rays) is again provided in the external region. In this exemplary embodiment, the anode body 3 is fabricated from an appropriate fiber-mat semi-finished part.

The heat conducting fibers 4 are arranged vertically, differently than in the cooled versions, i.e. parallel to the axis 10, such that a rapid removal of heat from the focal point is enabled but an intense heating of the bearing system 9 is prevented.

Throughout the inventive embodiment of the anode body 3, the supporting structure of this rotating anode is comprised of composite fiber material that has fibers with especially high heat-conductivity, as well as fibers (the same or another type) with a high mechanical strength.

The direction of the fibers in the supporting anode structure is selected such that the fibers with high heat-conductivity can rapidly dissipate the heat from the path of the focus, and the fibers with high strength transfer the mechanical and thermo-mechanical forces to the supporting structure.

The configuration of the fibers with high heat-conductivity also can be oriented such that they conduct the heat from the path of the focus to a heat sink (for example, a cooled bearing system). Alternatively, they can be purposefully oriented such that, although a rapid heat dissipation ensues from the path of the focus, the poor heat conductivity transverse to the fiber orientation is used in order to keep heat away from ball bearing systems (for example, those that are non-cooled and therefore heat-sensitive).

A carbon composite fiber material or a composite material of high-modular fibers, with heat-conductivity in the direction of the fibers of a magnitude comparable to the heat-conductivity of copper, are suitable as the anode material.

One advantage of the inventive anode composition is good heat dissipation away from the focal point allowed by high capacities. CFC achieve in the direction of fiber up to 10-fold higher heat-conductivity as super-pure graphite or Mo. Given consistent heat records, FE-calculations show up to 300K lower focal ring temperatures than conventional anodes.

A further advantage is high strength with lower weight. Conventional Mo anodes for the CT application have a strength/thickness ratio of 78 MPa/g/cm³; graphite anodes, as they are sometimes used, have a ratio of 21 MPa/g/cm³; fiber composite materials such as, for example, CFC achieve up to 270 MPa/g/cm³, meaning that a higher anode rotation frequency is achievable, in particular higher rotation frequencies than with graphite anodes. At the same time, the layer stress due to its own weight and centrifugal forces in the CT gantry is not larger than with graphite anodes, and significantly smaller than for conventional Mo-C anodes.

Although modifications and changes may be suggested by those skilled in the art, it is the intention of the inventor to embody within the patent warranted hereon all changes and modifications as reasonably and properly come within the scope of his contribution to the art.

I claim as my invention:

1. A rotating anode for an x-ray tube, said rotating anode comprising:
an anode body having a target surface with a focal ring;
a bearing system supporting said anode body; and
said anode body being comprises of composite fiber material having fibers exhibiting high heat conductivity and high mechanical strength.

2. A rotating anode as claimed in claim 1 wherein said fibers comprise first fibers having said high heat conductivity and second fibers having said high mechanical strength.

3. A rotating anode as claimed in claim 2 wherein said first fibers are oriented in said anode body to rapidly dissipate heat from said focal ring, and wherein said second fibers are oriented in said anode body to bear mechanical and thermo-mechanical forces in said anode body.

4. A rotating anode as claimed in claim 2 wherein said first fibers are oriented radially in said anode body and wherein said second fibers are oriented annularly in said anode body.

5. A rotating anode as claimed in claim 2 wherein said bearing system is a cooled bearing system, and wherein said first fibers conduct heat from said focal ring to said cooled bearing system.

6. A rotating anode as claimed in claim 2 wherein said bearing system is a non-cooled bearing system, and wherein said first fibers are oriented in said anode body for rapid heat removal from said anode body without intense heating of said bearing system.

7. A rotating anode as claimed in claim 6 wherein said first fibers are oriented substantially parallel to said bearing system.

8. A rotating anode as claimed in claim 1 wherein all of said fibers in said anode body have said high heat conductivity and said high mechanical strength, and wherein some of said fibers are oriented radially in said anode body and some of said fibers are oriented annularly in said anode body.

9. A rotating anode as claimed in claim 1 wherein said anode body is a formed component.

10. A rotating anode as claimed in claim 1 wherein said anode body is formed of a shaped fiber mat of said fibers.

11. A rotating anode as claimed in claim 1 wherein said anode body is a semi-finished fiber mat component.
